(19) United States
(12) Patent Application Publication
(10) Pub. No.: US 2026/0221900 A1
(43) Pub. Date: Jul. 30, 2026

(54) TRIBOELECTRIC GENERATOR BASED ON MULTILAYER MATERIALS

(71) Applicant: ENERGY MINING Co., Ltd., Suwon-si (KR)

(72) Inventors: Hyunmoon PARK, Gunpo-si (KR); Jeongun CHOE, Suwon-si (KR); Subin CHOI, Suwon-si (KR)

(73) Assignee: ENERGY MINING Co., Ltd., Suwon-si (KR)

(21) Appl. No.: 19/053,176

(22) Filed: Feb. 13, 2025

(30) Foreign Application Priority Data
Jan. 24, 2025 (KR) 10-2025-0011490

(51) Int. Cl. H02N 1/04

(52) U.S. Cl. CPC H02N 1/04

(57) ABSTRACT

The present disclosure relates to a triboelectric generator including: a first housing rotated by an external force and having a first hole through which a rotating shaft extending in a first direction passes; a rotating part having a second hole through which the rotating shaft passes to be rotated by the rotating shaft, and including a first insulating layer, a first electrode layer, and a first triboelectric layer, which are arranged in a direction opposite to the first direction; and a fixed part having a third hole through which the rotating shaft passes, and including a second insulating layer, a second electrode layer, and a second triboelectric layer, which are arranged in the first direction.

### CROSS REFERENCE TO RELATED APPLICATION OF THE DISCLOSURE

The present application claims the benefit of Korean Patent Application No. 10-2025-0011490 filed in the Korean Intellectual Property Office on Jan. 24, 2025, the entire contents of which are incorporated herein by reference.

### BACKGROUND OF THE INVENTION

### Field of the Invention

The present disclosure relates to a power generator, and more specifically, to a triboelectric generator based on multilayer materials with improved mobility of positive and negative charges.

### Background Art

A triboelectric nanogenerator (TENG) is an apparatus which generates charges through the process of contact and separation between different materials and converts the charges into electrical energy. Recently, the triboelectric nanogenerator have been extended into a multilayer-structure generator, gaining attention as a self-powered energy supply solution.

Triboelectric generation has distinct advantages such as lightweightness, flexibility, efficiency, and eco-friendliness, and holds great potential for various applications since the triboelectric nanogenerator can integrally perform energy harvesting and storage. Specifically, the triboelectric generator utilizing rotational motion induces movement of charges by utilizing triboelectric materials between rotating parts and fixed parts, thereby generating alternating current (AC) electricity or direct current (DC) electricity.

A conventional triboelectric generation structure is categorized into an alternating current (AC) type and a direct current (DC) type. In the AC-type structure, positive and negative charges are periodically separated due to the relative motion between the rotating parts and the fixed parts. The generated potential difference is transferred to an external circuit through electrodes, producing AC power. In contrast, the DC-type structure directly generates DC electricity by controlling the directionality of charges.

A rotation-based triboelectric generation system converts external physical energy in the vertical or horizontal direction into rotational motion. During the above process, periodic contact and separation between the triboelectric materials due to friction occur, thereby generating electrical output.

In a single-layer rotation-based triboelectric nanogenerator (TENG), rotating parts are alternately arranged with fixed parts for positive and negative charges, and the fixed parts convert the charges into AC power through the processes of induction, transfer, and concentration. As a result, physical energy is converted into rotational motion, and performs efficient power generation based on the triboelectric generation principle.

However, a multilayer rotation-based triboelectric nanogenerator has the problem of parallelization due to an increase of the power generation capacity. The multilayer rotation-based triboelectric nanogenerator may interfere with a charge transfer path if a significant potential difference occurs between the layers. So, the interference causes mutual interference in the charge accumulation and release process of each layer, thus reducing the overall power generation efficiency.

### SUMMARY OF THE INVENTION

In previous studies, the charge emission characteristics of triboelectric materials and the electron affinity of negative charges have been investigated as key factors in the power generation efficiency of triboelectric nanogenerators. The greater the triboelectric series difference between positive and negative charges and the higher the charge density of a material, the higher the power generation tends to be. For example, the combination of PTFE (negative charge property) with nylon (positive charge property) or the combination of Kapton and MXene form strong potential differences.

However, simply relying on the difference in the triboelectric series is often insufficient to secure adequate power generation because the triboelectric series theory does not fully reflect material surface characteristics, experimental conditions, and external environmental factors. Additionally, materials with extremely large triboelectric series differences may experience unstable charge transfer as the next friction cycle begins before the charge separation and movement processes are completed. Materials like MXene are also vulnerable to oxygen and humidity, leading to high initial power generation but gradual degradation over time.

According to previous researches, increasing the number of layers in the multilayer rotation-based triboelectric nanogenerator results in little change in voltage while current tends to increase proportionally to the number of stacked layers. However, if a significant potential difference occurs between the layers, certain charges may lead to mutual interference among parallel layers during the movement, thus decreasing overall power generation.

Specifically, in a small-scale rotation-based triboelectric generation system with areas of only a few square centimeters, when the current increases beyond several mA and the voltage exceeds 1 kV, a specific layer is affected in power generation process depending on the generation quantity of other layers which generate power in synchronization with the specific layer. As a result, the charge flow in the upper layers is adjusted to match that of the lower layers, leading to an overall reduction in power output.

Accordingly, to solve the above-mentioned problems occurring in the prior arts, the present disclosure provides a triboelectric generator including a multilayer-structure fixed part having an intermediate material layer. The fixed part includes a positive charge-inducing material, a negative charge-inducing material, and an intermediate material. The layered structure, which includes the intermediate material, enhances the potential difference between triboelectric materials and increases charge transfer efficiency, thus improving power generation. Additionally, in embodiments of the present disclosure, silicon utilized as the intermediate material layer has a very low elastic modulus (GPa), allowing for maximum transfer of physical friction force while maintaining high elastic recovery properties.

The intermediate material in the present disclosure accelerates the charge exchange rate between positive and negative charges and optimizes a charge transfer path through an electric field concentration effect.

Furthermore, the rotating part in the present disclosure includes the same material as the charge-inducing material (either positive charge-inducing material or a negative charge-inducing material) of the fixed part to improve charge induction efficiency, thus reducing the triboelectric characteristic difference between the fixed parts and the rotating parts, and ensuring uniformity in charge transfer path.

In the present disclosure, the electrode layer formation process has been modified from a copper-nickel-gold (Cu—Ni—Au) process to a copper-silver-nickel-gold (Cu—Ag—Ni—Au) process. In the present disclosure, by adding silver to the electrode layer, the present disclosure enhances charge transfer speed and reduces energy loss.

However, the challenges described herein are merely illustrative and do not limit the scope of the present disclosure.

To accomplish the above objectives, according to the present disclosure, there is provided a triboelectric generator including: a first housing rotated by an external force and having a first hole through which a rotating shaft extending in a first direction passes; a rotating part having a second hole through which the rotating shaft passes to be rotated by the rotating shaft, and including a first insulating layer, a first electrode layer, and a first triboelectric layer, which are arranged in a direction opposite to the first direction; and a fixed part having a third hole through which the rotating shaft passes, and including a second insulating layer, a second electrode layer, and a second triboelectric layer, which are arranged in the first direction, wherein electrical energy is generated through triboelectrification between the first triboelectric layer and the second triboelectric layer due to the rotation of the rotating shaft and the rotating part, the first triboelectric layer has a single layer, and the second triboelectric layer has multiple layers having different triboelectric properties.

According to an embodiment of the present disclosure, the rotating part and the fixed part are each provided in plurality, and the plurality of rotating parts and the plurality of fixed parts are alternately arranged in the direction opposite to the first direction.

According to an embodiment of the present disclosure, the second triboelectric layer includes a positive charge-inducing material layer, an intermediate material layer, and a negative charge-inducing material layer, which are sequentially stacked in the first direction on the second insulating layer. The intermediate material layer is positioned between the positive charge-inducing material layer and the negative charge-inducing material layer in the triboelectric series.

According to an embodiment of the present disclosure, the positive charge-inducing material layer is made of the same material as the first triboelectric layer.

According to an embodiment of the present disclosure, the second triboelectric layer includes a negative charge-inducing material layer, an intermediate material layer, and a positive charge-inducing material layer, which are sequentially arranged in the first direction on the second insulating layer. The intermediate material layer is positioned between the negative charge-inducing material layer and the positive charge-inducing material layer in the triboelectric series, and the negative charge-inducing material layer is made of the same material as the first triboelectric layer.

According to an embodiment of the present disclosure, the intermediate material layer has a thickness of 100 μm or less.

According to an embodiment of the present disclosure, the negative charge-inducing material layer and the positive charge-inducing material layer have the same thickness.

According to an embodiment of the present disclosure, the intermediate material layer has odd-numbered layers stacked.

According to an embodiment of the present disclosure, each of the first electrode layer and the second electrode layer includes silver.

According to an embodiment of the present disclosure, each of the rotating part and the fixed part has a disk shape, and the second insulating layer of the fixed part includes a protrusion extending in a second direction intersecting the first direction from the disk shape.

According to an embodiment of the present disclosure, each of the plurality of layers forming the second triboelectric layer is composed of any one of perfluoroalkoxy (PFA), polyethylene terephthalate (PET), polyethylene terephthalate glycol-modified (PETg), polyimide (PI), and silicon (Si).

According to an embodiment of the present disclosure, the intermediate material layer transfers negative charges generated in the negative charge-inducing material layer to the positive charge-inducing material layer due to triboelectrification.

According to an embodiment of the present disclosure, the intermediate material layer is composed of silicon (Si), and the negative charge-inducing material layer is composed of perfluoroalkoxy (PFA).

According to an embodiment of the present disclosure, the size of the second hole is substantially the same as the penetration surface of the rotating shaft, and the third hole is greater than the second hole.

According to an embodiment of the present disclosure, the triboelectric generator further includes a bearing provided in the first hole and surrounding the rotating shaft.

Other aspects, features, and advantages besides those described above will become apparent from the following detailed description, claims, and drawings for realizing the present disclosure.

In addition, the general and specific aspects of the present disclosure may be realized using a system, a method, or a computer program, or a combination of the system, method, or computer program.

As described above, the triboelectric generator according to embodiments of the present disclosure can increase power generation by utilizing lower-cost materials such as PFA, PET, PI, and Si, without using conventional high-cost materials. In particular, the triboelectric generator according to embodiments of the present disclosure can improve the charge induction efficiency through an intermediate material layer, and expand the charge induction path and maximize the potential difference between electrodes by adding an intermediate material layer to the fixed part.

The triboelectric generator according to embodiments of the present disclosure is suitable for various applications, including implantable medical devices, IoT devices, small wind and hydroelectric generators. Additionally, the triboelectric generator according to embodiments of the present disclosure can transfer power by using a power management integrated circuit (PMIC) or a power converter that matches the power generation frequency, thus offering a simple structure.

The triboelectric generator according to embodiments of the present disclosure can provide flexibility in multilayer structures and material design, allowing for expansion into various triboelectric material combinations and stacking structures based on triboelectric series characteristics and application purposes.

The triboelectric generator according to embodiments of the present disclosure can minimize potential difference interference generated in the rotational structure having single-layer materials in frictional rotation. The triboelectric generator according to embodiments of the present disclosure can overcome the charge transfer path interference issue by optimizing the charge flow of each layer through a plurality of layers with different triboelectric properties, proactively preventing problems that may arise in lower layers with low power generation efficiency. Such a design does not require additional power source and, as long as a specific installation space is secured, offers miniaturization features regardless of location or environment. Specifically, the rotation-based triboelectric nanogenerator with the multilayer structure is more efficient than the single-layer structure. In the single-layer structure, the electric field is concentrated on one side, restricting the charge transfer path and increasing resistance, whereas in the multilayer structure, each layer independently forms a potential, dispersing the electric field and minimizing electrical resistance generated in each layer.

The triboelectric generator according to embodiments of the present disclosure can enhance the durability and stability. While conventional methods mainly propose coating treatment or use of composite materials to improve the durability and safety, the present disclosure increases power generation by adding the intermediate material layer to the fixed part, thus allowing existing high-durability and high-safety materials to be used without additional treatment. The above is considered a significant advantage that greatly enhances commercialization potential.

In embodiments of the present disclosure, silicon (Si) used as the intermediate material layer has a much lower elastic modulus (GPa) than PI, PET, and PFA (e.g., the elastic modulus (GPa) in the range of 0.01 to 0.1), resulting in low resistance to physical energy and high force transfer capability. Additionally, silicon used as the intermediate material layer has an elastic recovery force tens to hundreds of times higher than PI, PET, and PFA, contributing to the high resilience of the triboelectric generator. Thus, the triboelectric generator disclosed herein not only increases triboelectric generation but also significantly improves long-term durability.

The triboelectric generator according to embodiments of the present disclosure includes the fixed part with the improved electrode structure. The triboelectric generator of the present disclosure applies the copper-silver-nickel-gold process to the rotating parts and the fixed parts instead of the conventional ENIG process (copper-nickel-gold) to enhance charge transfer speed. Such a method adds silver (62 MS/m) onto copper (58 MS/m), alleviating the bottleneck phenomenon that occurs when charges move from copper to nickel. Specifically, The triboelectric generator of the present disclosure can increase charge transfer speed and minimize energy loss by adding a silver layer.

Such improvements simultaneously enhance the efficiency and durability of the rotation-based triboelectric generation system, significantly increasing the commercialization potential for various applications.

### BRIEF DESCRIPTION OF THE DRAWINGS

FIG. 1 is an exploded perspective view schematically illustrating a power generator according to an exemplary embodiment of the present disclosure.

FIG. 2 is an exploded perspective view schematically illustrating an internal structure of a power generator according to an exemplary embodiment of the present disclosure.

FIGS. 3A and 3B are an exploded perspective view and a cross-sectional view schematically illustrating a rotating part and a fixed part according to an exemplary embodiment of the present disclosure.

FIG. 4 is a perspective view schematically illustrating a partially assembled state of the power generator illustrated in FIG. 2.

FIG. 5 is a diagram schematically illustrating the rotating part and the fixed part according to an exemplary embodiment of the present disclosure.

FIG. 6 is a graph showing the power generation results of a power generator sample.

FIGS. 7A to 7D are graphs showing the power generation results of a sample combined under an 8N pressure as a triboelectric generator.

FIGS. 8A to 8D are graphs showing the power generation results of a sample combined under a 2N pressure as a triboelectric generator.

FIG. 9 is a thermographic image before and after the operation of a sample including a triboelectric layer.

FIGS. 10A to 10E are graphs showing the power generation results of additional samples combined under a 2N pressure as a triboelectric generator.

FIGS. 11A and 11B are graphs showing different power generation results based on the thickness of an intermediate material layer.

FIG. 12 is a diagram illustrating the impedance measured differently according to the number of layers of the intermediate material layer.

FIGS. 13 and 14 are diagrams illustrating application examples of the power generator according to an exemplary embodiment of the present disclosure.

### DETAILED DESCRIPTION OF THE PREFERRED EMBODIMENT

Since the present disclosure may have various modifications and several embodiments, embodiments are shown in the drawings and will be provided in the detailed description in detail. Effects and features of the present disclosure and methods of accomplishing the same may be understood more readily with reference to the following detailed description of embodiments and the accompanying drawings. However, the present disclosure is not limited to the embodiments set forth herein, and may be embodied in many different forms.

It will be understood that although the terms “first,” “second,” etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “arranged on,” another layer, region, or component, it can be directly or indirectly arranged on the other layer, region, or component. That is, for example, intervening layers, regions, or components may be present.

Sizes of elements in the drawings may be exaggerated for convenience of explanation. In other words, since sizes and thicknesses of components in the drawings are arbitrarily illustrated for convenience of explanation, the following embodiments are not limited thereto.

When a certain embodiment may be implemented differently, a particular process order may be performed differently from the described order. For example, two consecutively described processes may be performed substantially at the same time or performed in an order opposite to the described order.

In the present specification, “A and/or B” refers to A or B, or A and B. In addition, “at least one of A and B” refers to A or B, or A and B.

It will be understood that when a layer, region, or component is referred to as being connected to or coupled to another layer, region, or component, it may be directly connected or coupled to the other layer, region, or component, and/or indirectly connected to the other layer, region, or component with intervening elements therebetween. For example, when a layer, region, or component is referred to as being electrically connected to or coupled to another layer, region, or component, it may be electrically directly connected or coupled to the other layer, region, or component, and/or electrically indirectly connected to the other layer, region, or component with intervening elements therebetween.

The x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

As used herein, the term is intended to illustrate the embodiments but is not intended to limit the inventive concept. In this specification, the singular includes the plural unless specifically stated otherwise. It will be further understood that the terms “comprises,” “comprising,” “includes,” and/or “including,” when used herein, specify the presence of members, but do not preclude the presence or addition of one or more other members, unless otherwise specified.

A word “exemplary” used herein means “used as an example or illustration.” Any embodiment described herein as “exemplary” is not necessarily to be construed as desirable or advantageous over other embodiments.

Embodiments of the present disclosure may be described in terms of functions or blocks that perform functions. Blocks which may be referred to as ‘units’ or ‘modules’ in the present disclosure may be physically implemented by analog or digital circuits such as logic gates, integrated circuits, microprocessors, microcontrollers, memories, passive electronic components, active electronic components, optical components, hardwired circuits, and the like, and may optionally be driven by firmware and software. Additionally, a term ‘unit’ means software or hardware elements such as field programmable gate array (FPGA) or application-particular integrated circuit (ASIC), and a “unit” performs some functions. However, a “unit” is not limited to hardware or software. A “unit” may be configured to be included in a storage medium that may be addressed, or configured to play one or more processors. Accordingly, as an example, a “unit” includes elements such as software elements, object-oriented software elements, class components, or task elements, processes, functions, attributes, procedures, subroutines, segments of a program code, drivers, firmware, micro-codes, circuits, data, database, data structures, tables, arrays, or variables. Functions provided in elements or “units” may be combined into a small number of elements or “units,” or separated into additional elements or “units.”

An embodiment of the present disclosure may be implemented using at least one software program running on at least one hardware device, and capable of performing network management functions to control elements.

Spatially relative terms such as “below,” “beneath,” “lower,” “above,” and “upper” may be used to easily describe a relationship of one component with other components as illustrated in the drawings. Spatially relative terms are to be understood as a term that includes other directions of the element in use or operation in addition to the direction illustrated in the drawings. For example, in a case in which a component shown in the drawing is described as being “below” or “beneath” another member, when the component is turned upside down, the component may be placed “above” the other member. Thus, the exemplary term “below” may include both downward and upward directions. Components may be oriented in other directions, and thus, the spatially relative terms may be interpreted according to the orientation.

Unless otherwise defined, all terms (including technical and scientific terms) used herein may be used as having a meaning that can be understood in common by one of ordinary skill in the art. In addition, terms defined in a generally used dictionary are not interpreted ideally or excessively, unless otherwise defined explicitly and particularly.

Hereinafter, embodiments of the present disclosure will be described in detail with reference to the attached drawings, in which like reference numerals designate like elements and repetitive explanation thereof will be omitted.

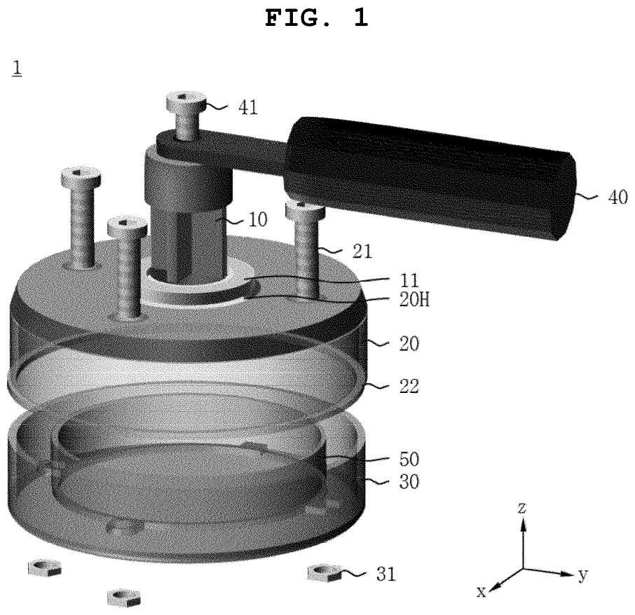

FIG. 1 is an exploded perspective view schematically illustrating a power generator according to an exemplary embodiment of the present disclosure.

Referring to FIG. 1, the power generator 1 may include a rotating shaft 10, a bearing 11, a first housing 20, a metal ring 22, a second housing 30, a handle 40, a power generation unit 50, bolts 21 and 41, and nuts 31.

The rotating shaft 10 extends in a first direction, e.g., the z-direction, and may penetrate the interiors of the first housing 20 and the second housing 30. The rotating shaft 10 may pass through a first hole 20H formed in the first housing 20. The rotating shaft 10 can rotate due to an external force.

The bearing 11 may be positioned inside the first hole 20H of the first housing 20 to surround the rotating shaft 10. The bearing 11 may be at least one of a ball bearing, a roller bearing, a plain bearing, a fluid bearing, a magnetic bearing, and a sleeve bearing. The bearing 11 can reduce static friction during the rotation of the rotating shaft 10, and minimize internal and external vibrations of the power generator 1.

The first housing 20 and the second housing 30 may form the external appearance of the power generator 1. The first housing 20 and the second housing 30 may be designed to accommodate components necessary for the operation of the power generator 1. At least one of the first housing 20 and the second housing 30 may accommodate the power generation unit 50.

The first housing 20 and the second housing 30 may be arranged to face each other. The first housing 20 and the second housing 30 may be fixed together. For example, as illustrated in FIG. 1, the first housing 20 may have holes for inserting the bolts 21. The second housing 30 may have holes through which the bolts 21 that have penetrated the first housing 20 can pass. The bolts 21 passing through the first housing 20 and the second housing 30 may be fastened with nuts 31, and the first housing 20 and the second housing 30 may be secured together using a threaded method or a hole-fixing method.

The metal ring 22 may be placed at the edge of the first housing 20. Alternatively, the metal ring 22 may be positioned inside the first housing 20. The metal ring 22 may serve to prevent electromagnetic interference (EMI) inside or outside the power generator 1.

The handle 40 extends in a second direction, e.g., the y-direction, perpendicular to the first direction, e.g., the z-direction, and may be connected to the rotating shaft 10. The handle 40 may be fixed to the rotating shaft 10 by the bolt 41. An external force is applied to the handle 40, and the applied external force may be transferred to the rotating shaft 10 through the handle 40.

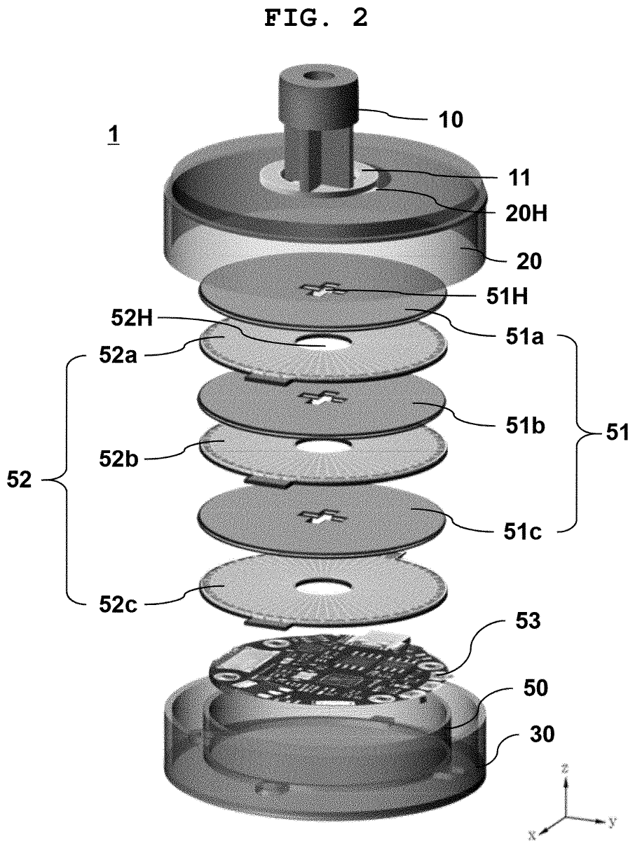

In FIG. 2, the power generation unit 50 may accommodate a rotating part, a fixed part, and a wireless communication and AC-DC conversion board, which will be described later. As illustrated in FIG. 1, the power generation unit 50 may be accommodated inside the second housing 30.

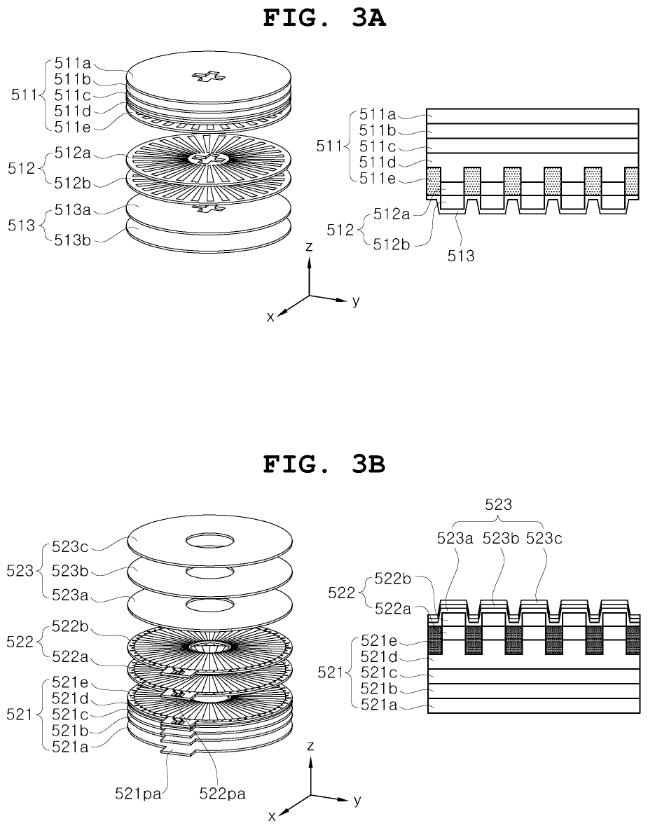

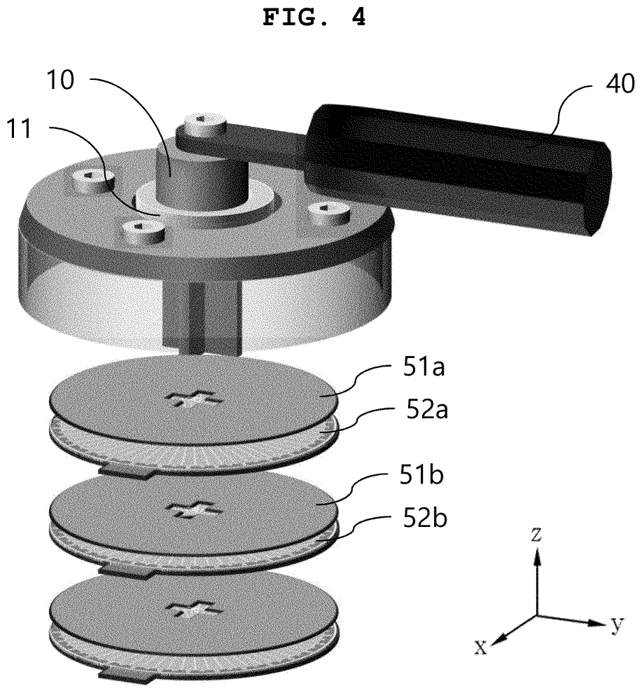

FIG. 2 is an exploded perspective view schematically illustrating an internal structure of a power generator according to an exemplary embodiment of the present disclosure, FIGS. 3A and 3B are an exploded perspective view and a cross-sectional view schematically illustrating a rotating part and a fixed part according to an exemplary embodiment of the present disclosure, and FIG. 4 is a perspective view schematically illustrating a partially assembled state of the power generator illustrated in FIG. 2.

Referring to FIG. 2, the power generator 1 may further include a rotating part 51, a fixed part 52, and a wireless communication and AC-DC conversion board 53.

The rotating part 51 has a second hole 51H through which the rotating shaft 10 passes, and the fixed part 52 has a third hole 52H through which the rotating shaft 10 passes. The size of the second hole 51H is substantially the same as the penetration surface of the rotating shaft 10, and the size of the third hole 52H may be larger than that of the second hole 51H. For example, as illustrated in FIG. 2, the penetration surface of the rotating shaft 10 and the second hole 51H may have a cross shape, and the third hole 52H may be circular. The rotating part 51 can rotate together with the rotating shaft 10 through the second hole 51H.

In one embodiment, the rotating part 51 and the fixed part 52 may have a substantially disk shape.

In one embodiment, the rotating part 51 and the fixed part 52 may each be plural in number. The plurality of rotating parts 51 and fixed parts 52 may be alternately arranged in the direction opposite to the first direction, e.g., the −z direction. For example, as illustrated in FIG. 2, the rotating part 51 may include first to third rotating parts 51a, 51b, and 51c, and the fixed part 52 may include first to third fixed parts 52a, 52b, and 52c. The first fixed part 52a is positioned between the first rotating part 51a and the second rotating part 51b, the second rotating part 51b is positioned between the first fixed part 52a and the second fixed part 52b, the second fixed part 52b is positioned between the second rotating part 51b and the third rotating part 51c, and the third rotating part 51c is positioned between the second fixed part 52b and the third fixed part 52c.

Referring to FIG. 4, the multiple rotating parts 51a and 51b and fixed parts 52a, 52b may be alternately arranged and assembled to the rotating shaft 10.

Referring to FIG. 3A, the rotating part 51 may include a first insulation layer 511, a first electrode layer 512, and a first triboelectric layer 513. The first insulation layer 511, the first electrode layer 512, and the first triboelectric layer 513 may be sequentially arranged in the direction opposite to the first direction, e.g., the −z direction. In FIG. 3B, the cross-sectional view on the right side shows protruding and recessed areas, but the exploded perspective view on the left side shows a relatively flat disk shape. It should be noted that a portion of the first insulation layer 511 (e.g., 511e) and the first electrode layer 512 are configured in a fan shape and the protruding areas are exaggerated in the cross-sectional view for explanation purposes. The embodiment of the present disclosure is actually very thin, so the actual structure may appear almost flat, as illustrated in the perspective view on the left.

The first insulation layer 511 may include FR4. The first insulation layer 511 may include a solder mask layer 511a, a copper layer 511b, a glass fiber layer 511c, a copper layer 511d, and a solder mask layer 511e which are sequentially arranged in the opposite direction to the first direction, e.g., the −z direction.

The first electrode layer 512 may be configured in a fan shape based on the rotating shaft 10. The first electrode layer 512 may be formed of at least two or more metal materials selected from gold (Au), silver (Ag), platinum (Pt), titanium (Ti), tin (Sn), copper (Cu), nickel (Ni), and zinc (Zn). The first electrode layer 512 may include a silver layer 512a and a gold layer 512b.

The first triboelectric layer 513 may include an adhesive material (e.g., a silicone-based adhesive material) 513a and a positive charge-inducing material 513b. The adhesive material 513a may be provided at a thickness of 50 μm or less to reduce vibrations caused by friction in the rotating part 51.

Referring to FIG. 3B, the fixed part 52 may include a second insulation layer 521, a second electrode layer 522, and a second triboelectric layer 523. The second insulation layer 521, the second electrode layer 522, and the second triboelectric layer 523 may be sequentially arranged in the first direction, e.g., the z direction. In FIG. 3B, the cross-sectional view on the right side shows protruding and recessed areas, but the exploded perspective view on the left side shows a relatively flat disk shape. It should be noted that a portion of the second insulation layer 521 (e.g., 521e) and the second electrode layer 522 are configured in a fan shape and the protruding areas are exaggerated in the cross-sectional view for explanation purposes. The embodiment of the present disclosure is actually very thin, so the actual structure may appear almost flat, as illustrated in the perspective view on the left.

The second insulation layer 521 may include FR4. The second insulation layer 521 may include a solder mask layer 521a, a copper layer 521b, a glass fiber layer 521c, a copper layer 521d, and a solder mask layer 521e which are sequentially arranged in the first direction, e.g., the z direction.

The second insulation layer 521 may further include a protrusion 521pa extending from the center of the disk shape in the second direction, e.g., the x direction, which intersects the first direction, e.g., the z direction.

In one embodiment, the protrusion 521pa may be fixed in a guide groove formed in the first housing 20, the second housing 30, or the power generation unit 50, as illustrated in FIG. 2. The fixed part 52 may be fixed even when the rotating shaft 10 rotates through the protrusion 521pa fixed to the first housing 20, the second housing 30, or the power generation unit 50.

The second electrode layer 522 may be configured in a fan shape based on the rotating shaft 10. The second electrode layer 522 may be formed of at least two or more metal materials selected from gold (Au), silver (Ag), platinum (Pt), titanium (Ti), tin (Sn), copper (Cu), nickel (Ni), and zinc (Zn). The second electrode layer 522 may include a silver layer 522a and a gold layer 522b.

The second triboelectric layer 523 may be formed of multiple layers with different triboelectric properties. Each of the multiple layers forming the second triboelectric layer may be formed of one of perfluoroalkoxy (PFA), polyethylene terephthalate (PET), polyethylene terephthalate glycol-modified (PETg), polyimide (PI), or silicon (Si). The second triboelectric layer 523 may include a positive charge-inducing material layer 523a, an intermediate material layer 523b, and a negative charge-inducing material layer 523c, which are sequentially stacked in the first direction (e.g., +z-axis direction) on the second insulation layer 521.

The positive charge-inducing material layer 523a may be formed of the same material as the first triboelectric layer 513. The positive charge-inducing material layer 523a may be positioned relatively higher in the triboelectric series. The positive charge-inducing material layer 523a may include polyethylene terephthalate (PET), polyethylene terephthalate glycol-modified (PETg), polyimide (PI), or polytetrafluoroethylene (PTFE).

The intermediate material layer 523b may be a material positioned between the positive charge-inducing material layer 523a and the negative charge-inducing material layer 523c in the triboelectric series. The intermediate material layer 523b may transfer the negative charges generated in the negative charge-inducing material layer 523c to the positive charge-inducing material layer 523a through triboelectrification. The intermediate material layer 523b may include silicon (Si), polyethylene terephthalate (PET), or polyimide (PI). The thickness of the intermediate material layer 523b may be 100 μm or less, preferably 50 μm or less. When the intermediate material layer 523b is made of silicon, vibrations caused by friction in the fixed part 52 can be reduced.

The negative charge-inducing material layer 523c may be positioned relatively lower in the triboelectric series. The negative charge-inducing material layer 523c may generate triboelectricity through repeated contact and separation with the first triboelectric layer 513. Negative charges may be generated from the negative charge-inducing material layer 523c. The negative charge-inducing material layer 523c may include PFA perfluoroalkoxy (PFA). The negative charge-inducing material layer 523c may have the same thickness as the positive charge-inducing material layer 523a.

An output unit 522pa may be positioned on the upper surface (+z direction) of the protrusion 521pa.

The rotating part 51 may be rotated by the rotation of the rotating shaft 10, and electrical energy may be generated by triboelectrification between the first triboelectric layer 513 and the second triboelectric layer 523. The generated electrical energy may be transferred through the output unit 522pa to the wireless communication and AC-DC conversion board 53. The wireless communication and AC-DC conversion board 53 may utilize the transferred electrical energy to request for disaster relief in situations such as mountain distress or natural disasters.

Although it has been described that the second triboelectric layer 523 includes the positive charge-inducing material layer 523a, the intermediate material layer 523b, and the negative charge-inducing material layer 523c sequentially stacked in the first direction (e.g., +z-axis direction) on the second insulation layer 521, the second triboelectric layer 523 may include a negative charge-inducing material layer, an intermediate material layer, and a positive charge-inducing material layer sequentially stacked in the first direction on the second insulation layer 521. In this case, the negative charge-inducing material layer may be formed of the same material as the first triboelectric layer 513.

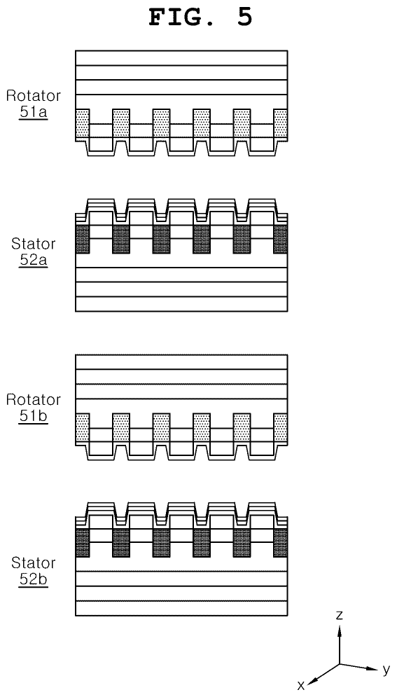

FIG. 5 is a diagram schematically illustrating the rotating part and the fixed part according to an exemplary embodiment of the present disclosure.

Referring to FIG. 5, the rotating parts and the fixed parts may each be plural in number. The plurality of rotating parts and the plurality of fixed parts may be alternately arranged in the direction opposite to the first direction, e.g., the −z axis direction.

Electrical energy may be generated by triboelectrification between the first rotating part 51a and the first fixed part 52a, and electrical energy may also be generated by triboelectrification between the second rotating part 51b and the second fixed part 52b. Hereinafter, the power generation results of the triboelectric generator will be described.

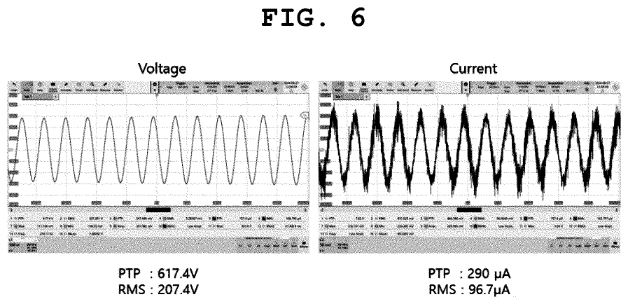

FIG. 6 is a graph showing the power generation results of a triboelectric generator sample.

Referring to FIG. 6, in the second triboelectric layer 523, the power generation results of a triboelectric generator sample including polyethylene terephthalate (PET) as the positive charge-inducing material layer 523a, silicon (Si) as the intermediate material layer 523b, and perfluoroalkoxy (PFA) as the negative charge-inducing material layer 523c can be observed.

The left graph shows the voltage output of the triboelectric generator sample, and the right graph shows the current output.

The voltage graph exhibits a periodic and symmetrical alternating current (AC) waveform, and shows a stable voltage output. Key data recorded include a peak-to-peak (PTP) voltage of 617.4V and a root mean square (RMS) voltage of 207.4V. The data indicates that the sample has a high voltage fluctuation range and generates a stable effective voltage. The power generation frequency remains constant at approximately 274.7 Hz, so it implies stable output and the potential for periodic power supply.

In the current graph, the current output is periodic but contains high-frequency components and some noise. Key data recorded include a peak-to-peak (PTP) current of 290 μA and a root mean square (RMS) voltage of 96.7 μA. The data indicates that the generator outputs not only voltage but also an appropriate level of current. Overall, the sample is a power generator which stably outputs both voltage and current and is a high-efficiency power generator.

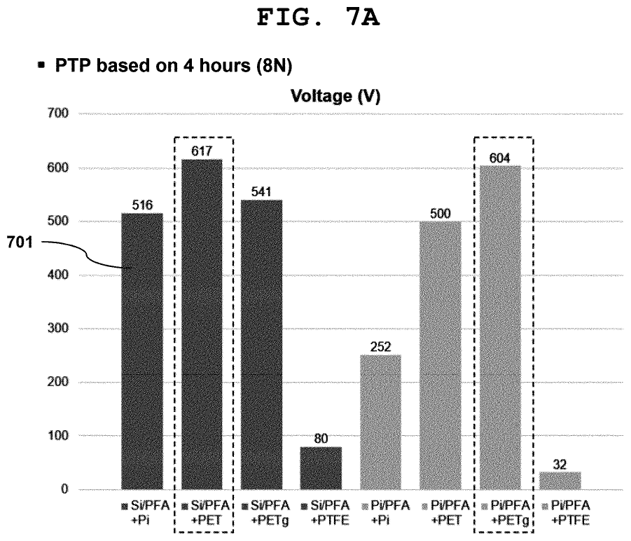

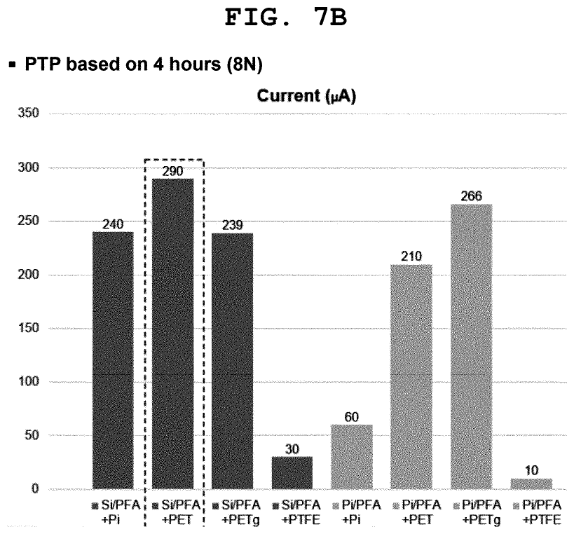

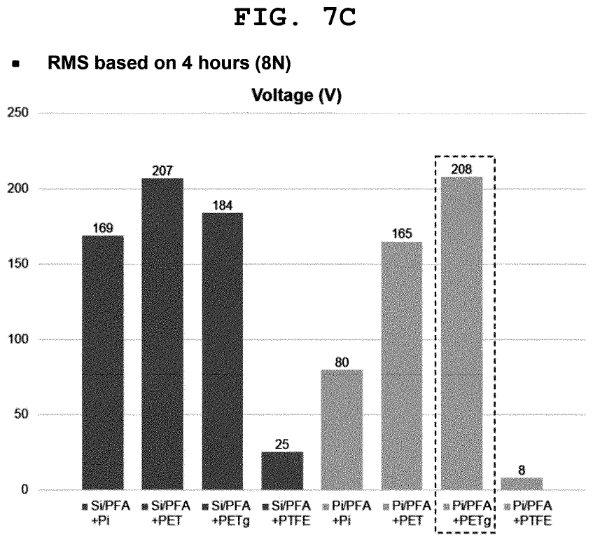

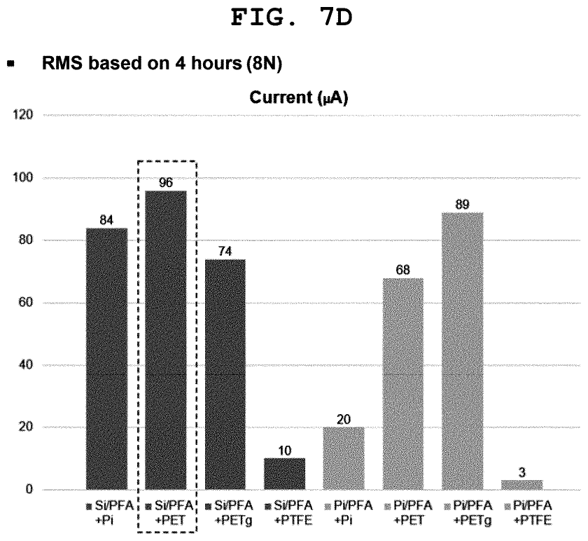

FIGS. 7A to 7D are graphs showing the power generation results of a sample combined under an 8N pressure as a triboelectric generator.

As described above, the triboelectric layer having multiple layers can be bonded under a pressure of 8N. A triboelectric generator sample fabricated in this manner was operated for four hours at 400 RPM.

Referring to FIG. 7A, the peak-to-peak (PTP) voltage values of triboelectric generator samples, a total of eight samples, with different combinations of the multiple layers of the charging layer, e.g., the positive charge-inducing material layer 523a, the intermediate material layer 523b, and the negative charge-inducing material layer 523c, can be observed.

For example, a leftmost bar graph 701 is labeled Si/PFA+PI, indicating the result value of the sample including the intermediate material layer 523b of silicon (Si), the negative charge-inducing material layer 523c of perfluoroalkoxy (PFA), and the positive charge-inducing material layer 523a of polyimide (PI).

Referring to FIG. 7B, the peak-to-peak (PTP) current values of the same samples as in FIG. 7A can be observed. Referring to FIG. 7C, the root mean square (RMS) voltage values of the same samples as in FIG. 7A can be observed. Referring to FIG. 7D, the root mean square (RMS) current values of the same samples as in FIG. 7A can be observed.

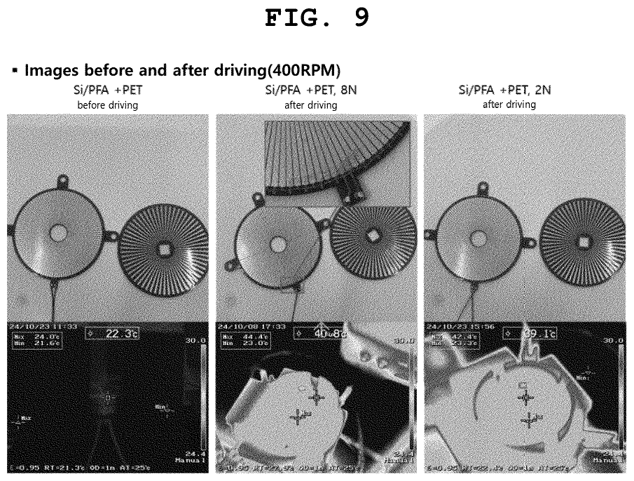

Among the eight samples, the sample Si/PFA+PET exhibited the best output performance. However, it was confirmed that the samples combined under a pressure of 8N sustained damage after operation (Refer to the middle image in FIG. 9). Therefore, further experiments will be conducted by combining samples under a pressure of 2N.

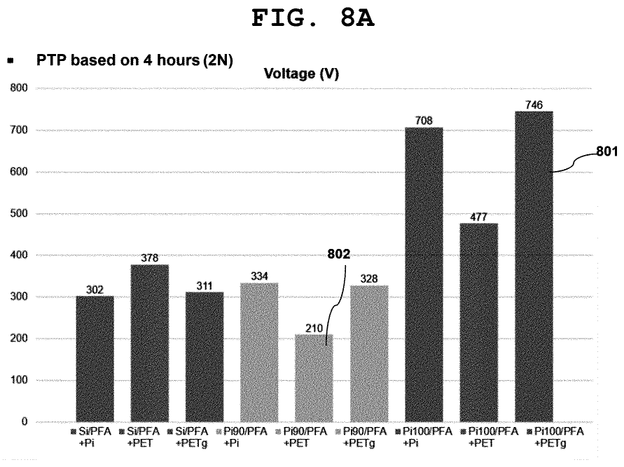

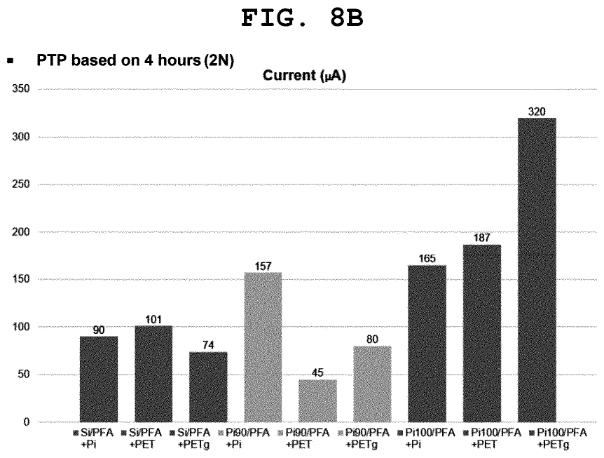

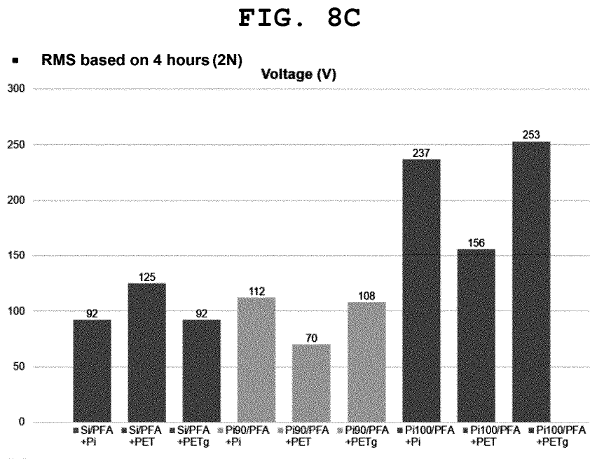

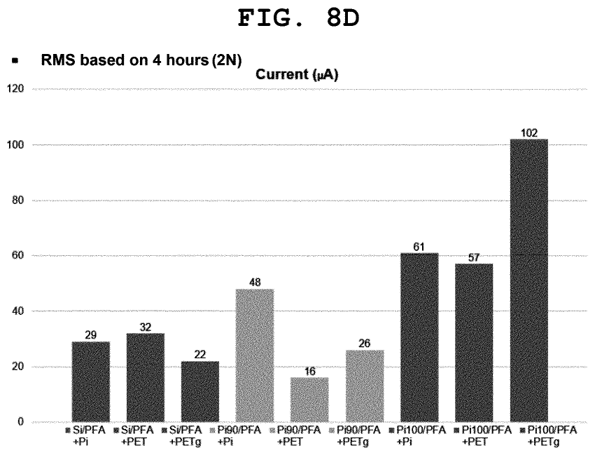

FIGS. 8A to 8D are graphs showing the power generation results of a sample combined under a 2N pressure as a triboelectric generator.

Referring to FIG. 8A, the peak-to-peak (PTP) voltage values of triboelectric generator samples, a total of nine samples, with different combinations of the multiple layers of the charging layer, e.g., the positive charge-inducing material layer 523a, the intermediate material layer 523b, and the negative charge-inducing material layer 523c, can be observed.

For example, a rightmost bar graph 801 is labeled PI100/PFA+PETg, indicating the result value of the sample including the intermediate material layer 523b of 100 μm PI (Polyimide), the negative charge-inducing material layer 523c of perfluoroalkoxy (PFA), and the positive charge-inducing material layer 523a of polyethylene terephthalate glycol-modified (PETg).

For another example, a bar graph 802 located in the middle is labeled PI90/PFA+PET, indicating the result value of the sample including the intermediate material layer 523b of 90 μm PI (Polyimide), the negative charge-inducing material layer 523c of perfluoroalkoxy (PFA), and the positive charge-inducing material layer 523a of polyethylene terephthalate (PET). That is, variations in the thickness of the intermediate material layer 523b were applied.

Referring to FIG. 8B, the peak-to-peak (PTP) current values of the same samples as in FIG. 8A can be observed. Referring to FIG. 8C, the root mean square (RMS) voltage values of the same samples as in FIG. 8A can be observed. Referring to FIG. 8D, the root mean square (RMS) current values of the same samples as in FIG. 8A can be observed.

However, compared to the samples combined under a pressure of 8N, the samples combined under a pressure of 2N exhibited an overall decrease in output but showed no signs of damage (Refer to the right image in FIG. 9).

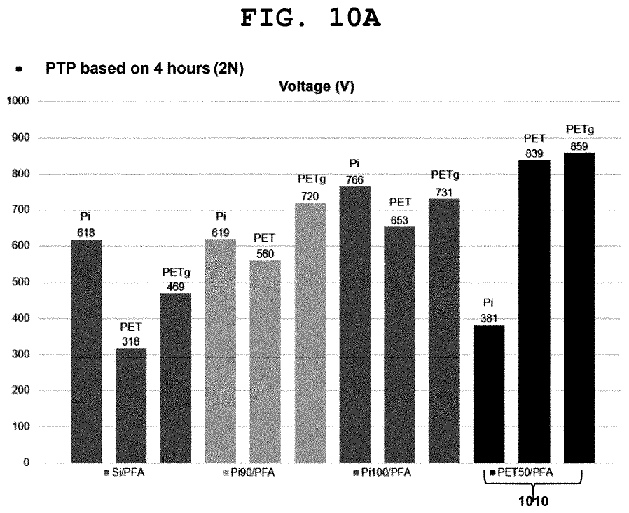

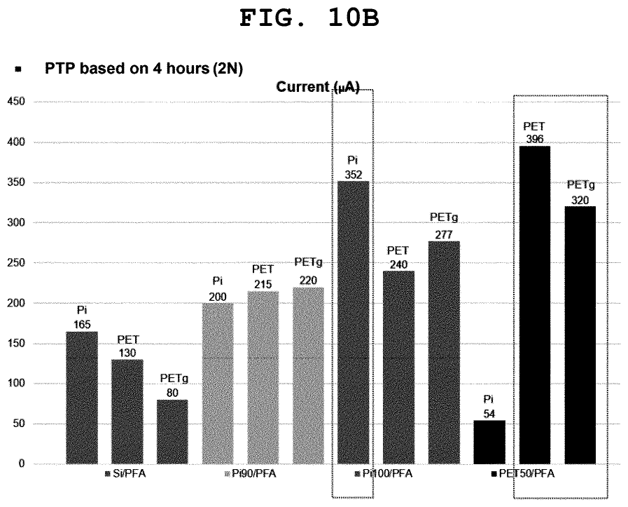

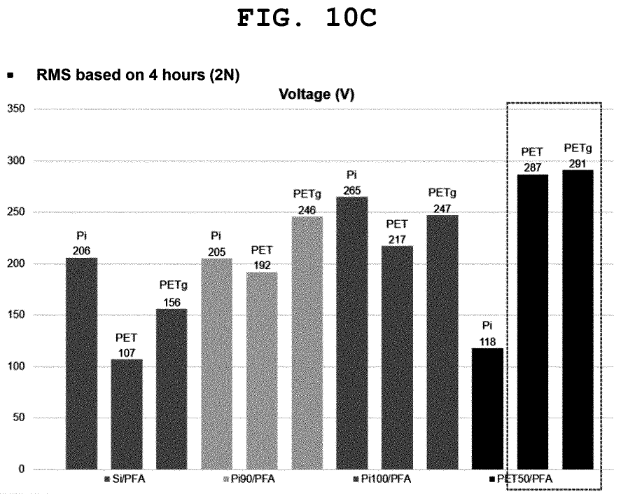

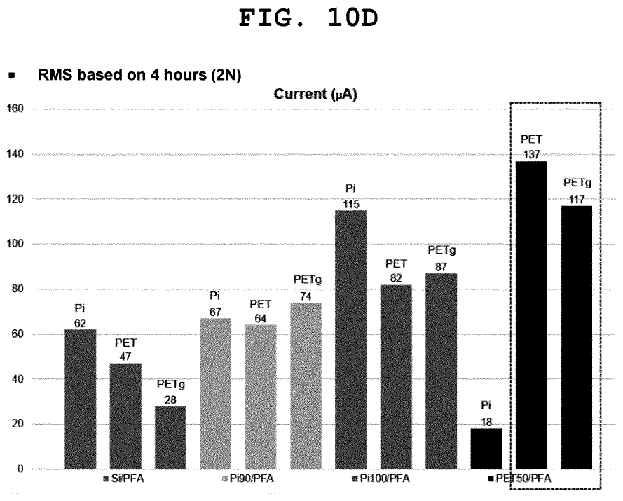

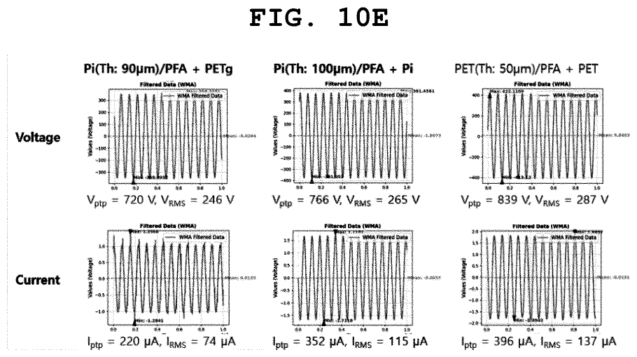

FIGS. 10A to 10E are graphs showing the power generation results of additional samples combined under a 2N pressure as a triboelectric generator.

Referring to FIG. 10A, the peak-to-peak (PTP) voltage values of triboelectric generator samples, a total of twelve samples, with different combinations of the multiple layers of the charging layer, e.g., the positive charge-inducing material layer 523a, the intermediate material layer 523b, and the negative charge-inducing material layer 523c, can be observed.

For example, a rightmost bar graph group 1010 is labeled PET50/PFA at the bottom, and labeled PETg, PET, and PI, which are arranged sequentially from right to left at the top of the graph, indicating the result values of three samples including the same intermediate material layers 523b of 50 μm polyethylene terephthalate (PET) and the same negative charge-inducing material layers 523c of perfluoroalkoxy (PFA) and different positive charge-inducing material layer 523a. The positive charge-inducing material layers 523a, positioned from right to left, are polyethylene terephthalate glycol-modified (PETg), polyethylene terephthalate (PET), and polyimide (PI).

Referring to FIG. 10B, the peak-to-peak (PTP) current values of the same samples as in FIG. 10A can be observed. Referring to FIG. 10C, the root mean square (RMS) voltage values of the same samples as in FIG. 10A can be observed. Referring to FIG. 10D, the root mean square (RMS) current values of the same samples as in FIG. 10A can be observed.

Among the twelve samples, the PET50/PFA+PET sample including the intermediate material layer 523b of 50 μm polyethylene terephthalate (PET), the negative charge-inducing material layer 523c of perfluoroalkoxy (PFA), and the positive charge-inducing material layer 523a of polyethylene terephthalate (PET) exhibited the highest output.

Referring to FIG. 10E, the power generation results of the combinations having the most optimal output identified through additional experiments can be observed. The combinations are as follows:
Combination 1: PI (Th: 90 μm)/PFA+PETg;
Combination 2: PI (Th: 100 μm)/PFA+PI; and
Combination 3: PET (Th: 50 μm)/PFA+PET.

Since the meaning of each combination has been sufficiently described above, redundant descriptions will be omitted. It can be observed that the maximum values are obtained when the intermediate material layer gets thinner. Hereinafter, for each sample having the three combinations above, the number of layers constituting the intermediate material layer is varied.

It has been previously described that the triboelectric layer provided in the fixed part may have multiple layers with different triboelectric properties. However, in Combination 2, the intermediate material layer is composed of 100 μm PI, and the positive charge-inducing material layer is also composed of PI, meaning that the two layers are made of the same material (e.g., PI).

Even when the layers are made of the same material, differences in thickness can vary charge accumulation, charge movement paths, surface charge density, and frictional contact characteristics, resulting in different charging properties. This is because the thickness of the layers directly affects the charge separation and accumulation mechanisms.

When the triboelectric layer is composed of a multilayer material, the greater the overall thickness of the second charging layer 523 and the thinner each layer of the second charging layer 523, the larger the potential difference. This is because the capacitance (electrical capacity) available for charge induction and accumulation increases.

On the other hand, when the triboelectric layer is composed of a single-layer material, a greater thickness results in a relative decrease in the potential difference between different materials, thus reducing the amount of charges arranged in the material and lowering the power generation output.

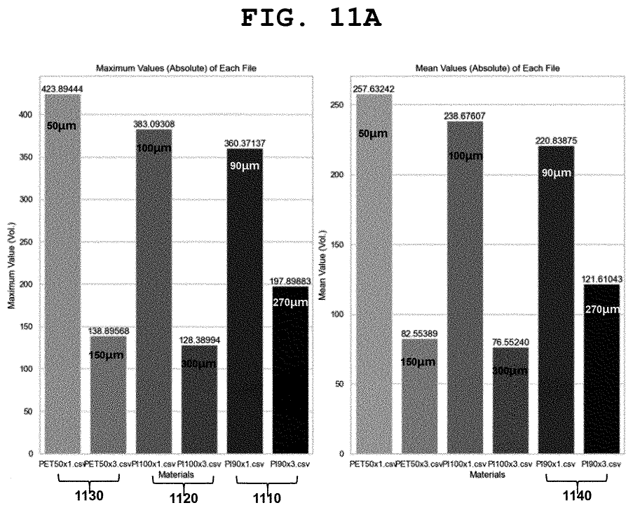

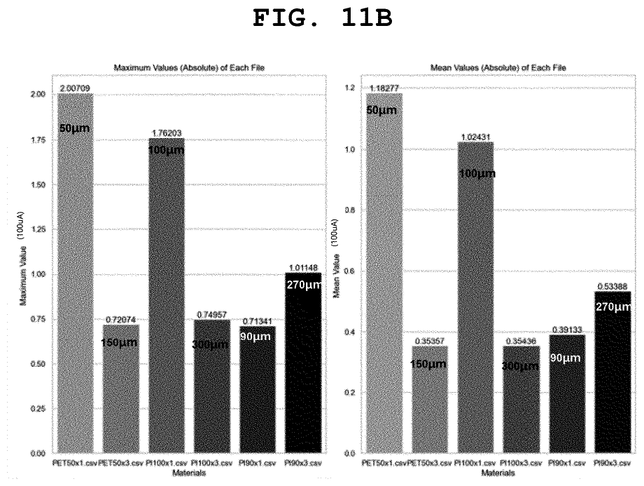

FIGS. 11A and 11B are graphs showing different power generation results based on the thickness of the intermediate material layer.

In FIG. 11A, a bar graph group 1110 represents the maximum voltage values measured after changing the thickness of the intermediate material layer (90 μm→270 μm) in the sample with Combination 1 of PI (Th: 90 μm)/PFA+PETg. A bar graph group 1120 represents the maximum voltage values measured after changing the thickness of the intermediate material layer (100 μm→300 μm) in the sample with Combination 2 of PI (Th: 100 μm)/PFA+PI. A bar graph group 1130 represents the maximum voltage values measured after changing the thickness of the intermediate material layer (50 μm→150 μm) in the sample with Combination 3 of PET (Th: 50 μm)/PFA+PET.

Additionally, in FIG. 11A, a bar graph group 1140 represents the average voltage values measured after changing the thickness of the intermediate material layer (90 μm→270 μm) in the sample with Combination 1 of PI (Th: 90 μm)/PFA+PETg. In FIG. 11A, the right-side graph represents the average voltage values, and the left-side graph represents the maximum voltage values.

Referring to FIG. 11B, the current values (unit: 100 μA) of the same sample as in FIG. 11A can be observed. It can be confirmed that when the intermediate material layer gets thinner, output is superior. The thickness for the intermediate material layer may be 100 μm, and preferably 50 μm.

Meanwhile, the thickness of the intermediate material layer can be adjusted by varying the number of layers of the intermediate material layer. For example, the intermediate material layer with the thickness of 50 μm may have a single layer of 50 μm thickness, and the intermediate material layer with the thickness of 150 μm may have three layers, each 50 μm thick. Increasing the number of layers of the intermediate material layer corresponds to increasing the overall thickness of the intermediate material layer.

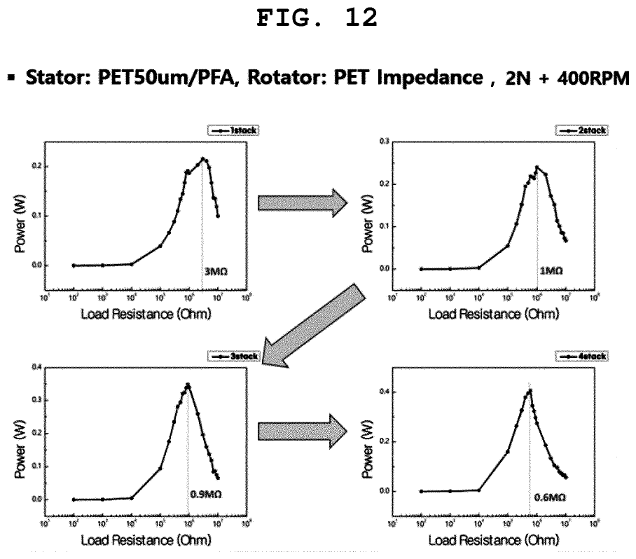

FIG. 12 is a diagram illustrating the impedance measured differently according to the number of layers of the intermediate material layer.

Referring to FIG. 12, the results of analyzing the generator's output power generated when varying the external load resistance can be observed. The graphs show the changes in the output power as additional layers are stacked in the intermediate material layer. The external resistance (impedance) values measured at the point of the maximum output power were 3 MΩ for one stack, 1 MΩ for two stacks, 0.9 MΩ for three stacks, and 0.6 MΩ for four stacks. As the number of stacks increased, the external resistance (impedance) gradually decreased. The impedance may be influenced by thickness and surface area. As the number of stacks increases, the overall thickness increases, reducing output values. However, since the total surface area increases as the number of stacks increases, the impedance value decreases.

Specifically, a sharp change in impedance was observed when transitioning from odd-numbered layers (one stack, and three stacks) to even-numbered layers (two stacks, and four stacks). This result clearly demonstrates the effect of the stacking structure on impedance characteristics and suggests that the generator's output characteristics can be optimized according to the combinations of the number of layers and the load resistance. In other words, it may be preferable for the intermediate material layer to be composed of odd-numbered layers.

As described above, the triboelectric generator according to embodiments of the present disclosure can increase power generation by utilizing lower-cost materials such as PFA, PET, PI, and Si, without using conventional high-cost materials. In particular, the triboelectric generator according to embodiments of the present disclosure can improve the charge induction efficiency through an intermediate material layer, and expand the charge induction path and maximize the potential difference between electrodes by adding an intermediate material layer to the fixed part.

The triboelectric generator according to embodiments of the present disclosure is suitable for various applications, including implantable medical devices, IoT devices, small wind and hydroelectric generators. Additionally, the triboelectric generator according to embodiments of the present disclosure can transfer power by using a power management integrated circuit (PMIC) or a power converter that matches the power generation frequency, thus offering a simple structure.

The triboelectric generator according to embodiments of the present disclosure can provide flexibility in multilayer structures and material design, allowing for expansion into various triboelectric material combinations and stacking structures based on triboelectric series characteristics and application purposes.

The triboelectric generator according to embodiments of the present disclosure can minimize potential difference interference generated in the rotational structure having single-layer materials in frictional rotation. The triboelectric generator according to embodiments of the present disclosure can overcome the charge transfer path interference issue by optimizing the charge flow of each layer through a plurality of layers with different triboelectric properties, proactively preventing problems that may arise in lower layers with low power generation efficiency. Such a design does not require additional power source and, as long as a specific installation space is secured, offers miniaturization features regardless of location or environment. Specifically, the rotation-based triboelectric nanogenerator with the multilayer structure is more efficient than the single-layer structure. In the single-layer structure, the electric field is concentrated on one side, restricting the charge transfer path and increasing resistance, whereas in the multilayer structure, each layer independently forms a potential, dispersing the electric field and minimizing electrical resistance generated in each layer.

The triboelectric generator according to embodiments of the present disclosure can enhance the durability and stability. While conventional methods mainly propose coating treatment or use of composite materials to improve the durability and safety, the present disclosure increases power generation by adding the intermediate material layer to the fixed part, thus allowing existing high-durability and high-safety materials to be used without additional treatment. The above is considered a significant advantage that greatly enhances commercialization potential.

The triboelectric generator according to embodiments of the present disclosure includes the fixed part with the improved electrode structure. The triboelectric generator of the present disclosure applies the copper-silver-nickel-gold process to the rotating parts and the fixed parts instead of the conventional ENIG process (copper-nickel-gold) to enhance charge transfer speed. Such a method adds silver (62 MS/m) onto copper (58 MS/m), alleviating the bottleneck phenomenon that occurs when charges move from copper to nickel. Specifically, The triboelectric generator of the present disclosure can increase charge transfer speed and minimize energy loss by adding a silver layer.

Such improvements simultaneously enhance the efficiency and durability of the rotation-based triboelectric generation system, significantly increasing the commercialization potential for various applications.

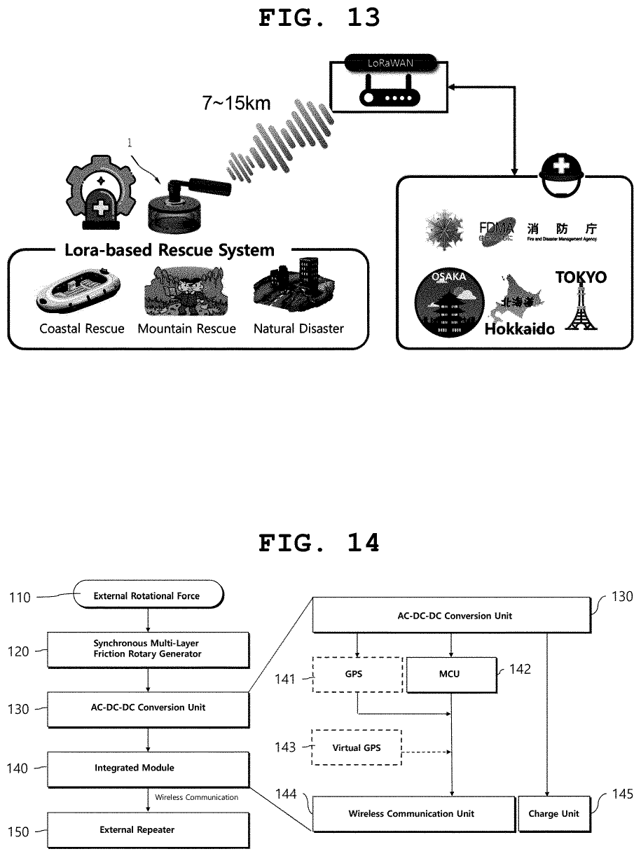

FIGS. 13 and 14 are diagrams illustrating application examples of the power generator according to an exemplary embodiment of the present disclosure.

Referring to FIG. 13, self-power generation or power generation based on centrifugal force can be widely applied in IoT and medical fields. For example, a dual-sided self-power generator 1 can be used as a self-powered rescue system. Traditional rescue systems rely on batteries to request for rescue. However, given the nature of rescue system environments, the rescue systems are used only once every few months or years in case of disasters or emergencies, making battery-based systems prone to dead battery in idle conditions. Specifically, in disaster situations or regions without power supply, it is difficult to provide power, necessitating remote rescue capabilities, for example, 7 km to 15 km, using a self-powered system. Such systems can also be utilized in various disaster situations, such as earthquakes, tsunamis, and heavy snowfall, in Japan.

Referring to FIG. 14, a self-powered rescue system 100 may include a synchronous multilayer frictional rotary power generation unit 120 connected to a mechanism including a bearing linked to a rotating shaft, an AC-DC-DC conversion unit 130, and an integrated module 140. The integrated module 140 may include a display device mounted on the mechanism or incorporated into the integrated module 140. The integrated module 140 may include a GPS module 141, an MCU 142, a virtual GPS module 143, a wireless communication module 144, and a charging unit.

A flowchart of the self-powered rescue system 100 is as follows. When a rescuer or a user who needs to transmit a location applies ‘external rotational force 110’, the rotational force enables the synchronous multilayer frictional rotary power generation unit 120 to generate electricity and supply power to the AC-DC-DC conversion unit 130. The AC-DC-DC conversion unit 130 converts the energy from power generation elements into electric power in an AC or DC circuit and supplies power of at least 100 ms to the MCU 142, the wireless communication unit 144, and the GPS 141. The GPS 141 collects location information for 100 ms and transmits the location information to the MCU 142. The MCU 142 then transmits GPS information to an external relay device 150 via wireless communication such as BLE, LoRa, or Wi-Fi. If the system does not have the GPS 141 to provide the location information, the MCU 142 can store virtualized GPS information 143 and transfer the virtualized GPS information to the wireless communication unit 144. The AC-DC-DC conversion unit 130 can be connected to the charging unit 145, enabling self-powered operation. So, the self-powered rescue system 100 can function as a smart terminal.

The embodiments of the present disclosure are described by focusing on the power generator, but it may be appreciated that the present invention is not limited to the forms mentioned in the above detailed description. For instance, a method of manufacturing the power generator also falls within the scope of the present disclosure.

While the present disclosure has been described with reference to the illustrated embodiments, the embodiments are only examples, and it will be appreciated by those skilled in the art that various modifications and equivalent other embodiments are possible from the present invention. Therefore, it may be appreciated that the actual technical protection scope of the present disclosure should be determined by the spirit of the appended claims.

This research was conducted with the support from the Korea Planning&Evaluation Institute of Industrial Technology and the Ministry of Trade, Industry and Energy(MOTIE) under the Next-Generation Intelligent Semiconductor Technology Development R&D Program (Project Identification Number: 1415187321, Project Number: 20025736, Research Project Title: Development of MICS SoC and Platform for Invivo Implantable Electroceutical Device).

This research was conducted with the support from the Korea Technology & Information Promotion Agency for SMEs(TIPA) and the Ministry of SMEs and Startups under the Startup Growth Technology Development Project (Project Identification Number: 2420003291, Project Number: 00445805, Research Project Title: Development of Miniaturized/High-Power Energy Solution for Battery-Free Electronic Medicine).

This research was conducted with the support from the Ministry of SMEs and Startups and the Korea Institute of Startup and Entrepreneurship Development(KISED) under the Ultra-Gap Startup Promotion Project (DIPS 1000+) (Project Number: 20241755, Research Project Title: Ultrasonic Energy Solution for Remotely Controllable, Battery-Free Electronic Medicine).

What is claimed is:

1. A triboelectric generator comprising:
a first housing rotated by an external force and having a first hole through which a rotating shaft extending in a first direction passes;
a rotating part having a second hole through which the rotating shaft passes to be rotated by the rotating shaft, and including a first insulating layer, a first electrode layer, and a first triboelectric layer, which are arranged in a direction opposite to the first direction; and
a fixed part having a third hole through which the rotating shaft passes, and including a second insulating layer, a second electrode layer, and a second triboelectric layer, which are arranged in the first direction,
wherein electrical energy is generated through triboelectrification between the first triboelectric layer and the second triboelectric layer due to the rotation of the rotating shaft and the rotating part,
wherein the first triboelectric layer has a single layer, and
wherein the second triboelectric layer has multiple layers having different triboelectric properties.

2. The triboelectric generator according to claim 1, wherein the rotating part and the fixed part are each provided in plurality, and
wherein the plurality of rotating parts and the plurality of fixed parts are alternately arranged in the direction opposite to the first direction.

3. The triboelectric generator according to claim 1, wherein the second triboelectric layer includes a positive charge-inducing material layer, an intermediate material layer, and a negative charge-inducing material layer, which are sequentially stacked in the first direction on the second insulating layer, and
wherein the intermediate material layer is positioned between the positive charge-inducing material layer and the negative charge-inducing material layer in the triboelectric series.

4. The triboelectric generator according to claim 3, wherein the positive charge-inducing material layer is made of the same material as the first triboelectric layer.

5. The triboelectric generator according to claim 1, wherein the second triboelectric layer includes a negative charge-inducing material layer, an intermediate material layer, and a positive charge-inducing material layer, which are sequentially arranged in the first direction on the second insulating layer,
wherein the intermediate material layer is positioned between the negative charge-inducing material layer and the positive charge-inducing material layer in the triboelectric series, and
wherein the negative charge-inducing material layer is made of the same material as the first triboelectric layer.

6. The triboelectric generator according to claim 3, wherein the intermediate material layer has a thickness of 100 μm or less.

7. The triboelectric generator according to claim 3, wherein the negative charge-inducing material layer and the positive charge-inducing material layer have the same thickness.

8. The triboelectric generator according to claim 3, wherein the intermediate material layer has odd-numbered layers stacked.

9. The triboelectric generator according to claim 1, wherein each of the first electrode layer and the second electrode layer includes silver.

10. The triboelectric generator according to claim 1, wherein each of the rotating part and the fixed part has a disk shape, and
wherein the second insulating layer of the fixed part includes a protrusion extending in a second direction intersecting the first direction from the disk shape.

11. The triboelectric generator according to claim 1, wherein each of the plurality of layers forming the second triboelectric layer is composed of any one of perfluoroalkoxy (PFA), polyethylene terephthalate (PET), polyethylene terephthalate glycol-modified (PETg), polyimide (PI), and silicon (Si).

12. The triboelectric generator according to claim 3, wherein the intermediate material layer transfers negative charges generated in the negative charge-inducing material layer to the positive charge-inducing material layer due to triboelectrification.

13. The triboelectric generator according to claim 3, wherein the intermediate material layer is composed of silicon (Si), and
wherein the negative charge-inducing material layer is composed of perfluoroalkoxy (PFA).

14. The triboelectric generator according to claim 1, wherein the size of the second hole is substantially the same as the penetration surface of the rotating shaft, and
wherein the third hole is greater than the second hole.

15. The triboelectric generator according to claim 1, further comprising:
a bearing provided in the first hole and surrounding the rotating shaft.
